(19) United States
(12) Patent Application Publication
(10) Pub. No.: US 2024/0323853 A1
(43) Pub. Date: Sep. 26, 2024

(54) SELECTION OF CONTROLLER AND/OR CALCULATIONS FOR RADIO FREQUENCY EXPOSURE COMPLIANCE

(71) Applicant: QUALCOMM Incorporated, San Diego, CA (US)

(72) Inventors: Michael Siddhartha ARPUTHARAJ, Hyderabad (IN); Kaushik BHATTACHARYA, Hyderabad (IN); Venkatesh SASANAPURI, Hyderabad (IN); Narasimhamurthy VEMPATI, Hyderabad (IN); Suman CHAKRABORTY, Hyderabad (IN)

(21) Appl. No.: 18/610,067

(22) Filed: Mar. 19, 2024

Related U.S. Application Data
(60) Provisional application No. 63/491,167, filed on Mar. 20, 2023.

(51) Int. Cl. H04W 52/02

(52) U.S. Cl. CPC H04W 52/0261

(57) ABSTRACT

Certain aspects of the present disclosure provide techniques and apparatus for selection of a controller for radio frequency (RF) exposure compliance. An example method of wireless communication includes controlling RF exposure associated with a plurality of radios via a first controller among a plurality of controllers for a first time period, and controlling the RF exposure associated with one or more radios of the plurality of radios via a second controller among the plurality of controllers for a second time period different from the first time period. Controlling the RF exposure may involve controlling the RF exposure associated with the one or more the radios in response to detecting one or more criteria being satisfied.

### CROSS-REFERENCE TO RELATED APPLICATION

This application claims the benefit of U.S. Provisional Patent Application Ser. No. 63/491,167, filed Mar. 20, 2023, which is hereby incorporated by reference herein in its entirety for all applicable purposes.

### INTRODUCTION

### Field of the Disclosure

Aspects of the present disclosure relate to wireless communications, and more particularly, to radio frequency (RF) exposure compliance.

### DESCRIPTION OF RELATED ART

Wireless communication systems are widely deployed to provide various telecommunication services such as telephony, video, data, messaging, broadcasts, etc. Modern wireless communication devices (such as cellular telephones) are generally mandated to meet radio frequency (RF) exposure limits set by certain governments and international standards and regulations. To ensure compliance with the standards, such devices may undergo an extensive certification process prior to being shipped to market. To ensure that a wireless communication device complies with an RF exposure limit, techniques have been developed to enable the wireless communication device to assess RF exposure from the wireless communication device and adjust the transmission power of the wireless communication device accordingly to comply with the RF exposure limit.

### SUMMARY

Certain aspects of the subject matter described in this disclosure can be implemented in a method of wireless communication by a wireless device. The method generally includes controlling radio frequency (RF) exposure associated with a plurality of radios via a first controller among a plurality of controllers for a first time period. The method also includes controlling the RF exposure associated with one or more radios of the plurality of radios via a second controller among the plurality of controllers for a second time period different from the first time period.

Certain aspects of the subject matter described in this disclosure can be implemented in an apparatus for wireless communication. The apparatus generally includes one or more memories collectively storing executable instructions and one or more processors coupled to the one or more memories. The one or more processors are collectively configured to execute the executable instructions to cause the apparatus to control radio frequency (RF) exposure associated with a plurality of radios via a first controller among a plurality of controllers for a first time period, and control the RF exposure associated with one or more radios of the plurality of radios via a second controller among the plurality of controllers for a second time period different from the first time period.

Certain aspects of the subject matter described in this disclosure can be implemented in an apparatus for wireless communication. The apparatus generally includes means for controlling radio frequency (RF) exposure associated with a plurality of radios via a first controller among a plurality of controllers for a first time period. The apparatus also includes means for controlling the RF exposure associated with one or more radios of the plurality of radios via a second controller among the plurality of controllers for a second time period different from the first time period.

Certain aspects of the subject matter described in this disclosure can be implemented in a computer-readable medium. The computer-readable medium has instructions stored thereon, that when executed by an apparatus, cause the apparatus to perform an operation. The operation generally includes controlling radio frequency (RF) exposure associated with a plurality of radios via a first controller among a plurality of controllers for a first time period. The operation also includes controlling the RF exposure associated with one or more radios of the plurality of radios via a second controller among the plurality of controllers for a second time period different from the first time period.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication system exhibiting radio frequency (RF) exposure to a human, in accordance with certain aspects of the present disclosure.

FIG. 2 is a block diagram conceptually illustrating a design of an example wireless communication device communicating with another device, in accordance with certain aspects of the present disclosure.

FIG. 3 is a graph illustrating examples of transmit powers over time in compliance with a RF exposure limit, in accordance with certain aspects of the present disclosure.

FIG. 4A is a diagram illustrating an example wireless device having multiple radios, in accordance with certain aspects of the present disclosure.

FIG. 4B is a diagram illustrating an example logical architecture for controlling the RF exposure associated with one or more radios, in accordance with certain aspects of the present disclosure.

FIG. 5 is a flow diagram illustrating example operations for wireless communication by a wireless device, in accordance with certain aspects of the present disclosure.

FIG. 6 illustrates a communications device that may include various components configured to perform operations for the techniques disclosed herein, in accordance with certain aspects of the present disclosure.

To facilitate understanding, identical reference numerals have been used, where possible, to designate identical elements that are common to the figures. It is contemplated that elements disclosed in one aspect may be beneficially utilized in other aspects without specific recitation.

### DETAILED DESCRIPTION

Aspects of the present disclosure provide apparatus, methods, processing systems, and computer-readable mediums for selection of a controller and/or calculations for radio frequency (RF) exposure compliance.

A wireless communication device may be capable of communicating via multiple radio access technologies (RATs), such as wireless wide area network (WWAN) RAT(s) (e.g., 5G New Radio (NR), Evolved Universal Terrestrial Radio Access (E-UTRA), Universal Mobile Telecommunications System (UMTS) and/or code division multiple access (CDMA)), wireless local area network (WLAN) RATs (e.g., Institute of Electrical and Electronics Engineers (IEEE) 802.11), short-range communications (e.g., Bluetooth), non-terrestrial communications, device-to-device (D2D) communications, vehicle-to-everything (V2X) communications, and/or other communications (e.g., future RAT(s)). In some cases, the wireless device may control RF exposure using a primary controller that controls the transmit power (and hence, the RF exposure) associated with particular radios for one or more RATs.

To control the RF exposure associated with multiple radios (e.g., WLAN, WWAN (E-UTRA/5G), and Bluetooth), the time-averaged evaluation may have two components: (i) an outer loop (OL) that periodically determines the transmit power limit for each of the radios (e.g., for a (running) time window), and (ii) an inner loop (IL) for each of the radios that uses the respective transmit power limit to determine its transmit power for a specific time interval of the running time window and/or for each packet. The OL may compute the transmit power limit based on a transmit power history report provided by the inner loop associated with each of the radios, where the transmit power history report may indicate the transmit powers used over time in the previous time interval(s) (or may include other indications or information, such as whether a particular radio was transmitting during that time interval and/or for how much of the time interval the radio was transmitting). As an example, a WWAN modem may control the RF exposure exhibited by the WWAN radio(s) in addition to the WLAN radio(s) and/or Bluetooth radio(s). In such a case, the WWAN modem may operate as the primary controller (e.g., performing the OL functions) for RF exposure compliance.

In some cases, the WWAN modem may be in a state where the WWAN modem is unable to operate as the primary controller with respect to RF exposure compliance, such as when the WWAN modem is in airplane mode or a low power mode (e.g., sleep mode) or when the wireless device is booting or waking from a low power state (e.g., sleep mode) and the WWAN modem may not be ready to communicate with the other radios as the WWAN modem initializes from the boot or wake-up sequence. In such cases, the other radios (e.g., WLAN and/or Bluetooth) may apply a conservative RF exposure limit (e.g., a relatively low maximum transmit power limit), which can affect the wireless communication performance associated with those radios (e.g., reduced throughput, increased latency, and decreased range). The other radio(s) may apply a conservative limit that can cause reduced performance, and in some cases, the other radio(s) may apply a default limit that may violate RF compliance (e.g., in cases where multiple radios (unknown to each other) are transmitting in the same RF exposure time window).

Aspects of the present disclosure provide apparatus and methods for selection of a (e.g., primary) controller for RF exposure compliance. As an example, suppose the WWAN modem, which is the active primary controller, is switched to airplane mode, and the WLAN modem has a processing capability (e.g., sufficient processing resources) to perform the primary controller's operations. In such a case, the WLAN modem may assume control of the RF exposure associated with the WLAN modem and any other (or a subset of the other) radios (e.g., Bluetooth communications). When the WWAN modem exits airplane mode, the WWAN modem may return to operating as the primary controller for RF exposure compliance. The selection of a controller among a plurality of controllers (e.g., modems and/or processors associated with any of various radios and/or RATs) may be based on any of various criteria, where the criteria may include traffic activity, a duty cycle, a processing load, a quality of service (QOS), one or more radio conditions, a priority, one or more capabilities of a controller, or any combination thereof. The selection of the controller may be in response to detecting the active primary controller (e.g., the WWAN modem) being in a particular state (e.g., airplane mode or sleep mode).

The apparatus and methods for selection of a controller described herein may provide various advantages. For example, selection of the controller may allow certain radios to transmit RF signals in compliance with RF exposure limits, preventing what is deemed to be harmful or undesirable exposure to human tissues. In certain cases, selection of the controller may allow certain radios to improve wireless communication performance (e.g., increased throughput, decreased latency, and/or increased transmission range).

The following description provides examples of selection of a controller for RF exposure compliance in communication systems, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs, or may support multiple RATs.

As used herein, a radio may refer to a physical or logical transmission path associated with one or more frequency bands (carriers, channels, bandwidths, subdivisions thereof, etc.), transmitters (or transceivers), and/or RATs (e.g., WWAN, WLAN, short-range communications (e.g., Bluetooth), non-terrestrial communications, D2D communications, V2X communications, etc.) used for wireless communications. For example, for uplink carrier aggregation (or multi-connectivity) in WWAN, each of the active component carriers used for wireless communications may be treated as a separate radio. Similarly, multi-band transmissions for IEEE 802.11 may be treated as separate radios for each frequency band (e.g., 2.4 gigahertz (GHz), 5 GHZ, and/or 6 GHz). In some examples, a radio is defined based on a RAT, frequency, and/or operation controlled by an inner loop (or equivalent when an outer loop is not operational or applicable) for the purposes of RF exposure determination and/or RF exposure compliance.

The techniques described herein may be used for various wireless networks and radio technologies. While aspects may be described herein using terminology commonly associated with 3G, 4G, and/or 5G (e.g., 5G NR) wireless technologies, aspects of the present disclosure can be applied in other generation-based communication systems and/or to wireless technologies such as IEEE 802.11, 802.15, etc.

### Example Wireless Communication Network and Devices

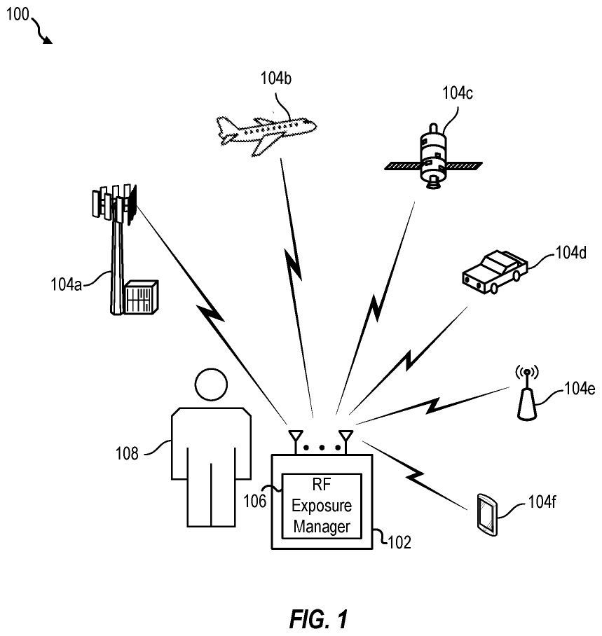

FIG. 1 illustrates an example wireless communication system 100 in which aspects of the present disclosure may be performed. For example, the wireless communication system 100 may include a wireless wide area network (WWAN) and/or a wireless local area network (WLAN). For example, a WWAN may include a New Radio (NR) system (e.g., a Fifth Generation (5G) NR network), an Evolved Universal Terrestrial Radio Access (E-UTRA) system (e.g., a Fourth Generation (4G) network), a Universal Mobile Telecommunications System (UMTS) (e.g., a Second Generation (2G)/Third Generation (3G) network), a code division multiple access (CDMA) system (e.g., a 2G/3G network), any future WWAN system, or any combination thereof. A WLAN may include a wireless network configured for communications according to an IEEE standard such as one or more of the 802.11 standards, etc. In some cases, the wireless communication system 100 may include a device-to-device (D2D) communications network or a short-range communications system, such as Bluetooth communications.

As illustrated in FIG. 1, the wireless communication system 100 may include a first wireless device 102 communicating with any of various second wireless devices 104a-104f (a second wireless device 104) via any of various radio access technologies (RATs), where a wireless device may refer to a wireless communication device. The RATs may include, for example, WWAN communications (e.g., E-UTRA and/or 5G NR), WLAN communications (e.g., IEEE 802.11), vehicle-to-everything (V2X) communications, non-terrestrial network (NTN) communications, short-range communications (e.g., Bluetooth), etc.

The first wireless device 102 may be emitting RF signals in proximity to a human 108, who may be the user of the first wireless device 102 and/or a bystander. As an example, the first wireless device 102 may be held in the hand of the human 108 and/or positioned against or near the head of the human 108. In certain cases, the first wireless device 102 may be positioned in a pocket or bag of the human 108. In some cases, the first wireless device 102 may positioned proximate to the human 108 as a mobile hotspot. To ensure the human 108 is not overexposed to RF emissions from the first wireless device 102, the first wireless device 102 may control the transmit power associated with the RF signals in accordance with an RF exposure limit, as further described herein, where the RF exposure limit may depend on the corresponding exposure scenario (e.g., head exposure, hand (extremity) exposure, body (body-worn) exposure, hotspot exposure, etc.).

The first wireless device 102 may include any of various wireless communication devices including a user equipment (UE), a wireless station, an access point, a customer-premises equipment (CPE), etc. In certain aspects, the first wireless device 102 includes an RF exposure manager 106 that selects a controller to control the RF exposure associated with one or more radios, in accordance with aspects of the present disclosure.

The second wireless devices 104a-104f may include, for example, a base station 104a, an aircraft 104b, a satellite 104c, a vehicle 104d, an access point 104e, and/or a UE 104f. Further, the wireless communication system 100 may include terrestrial aspects, such as ground-based network entities (e.g., the base station 104a and/or access point 104c), and/or non-terrestrial aspects, such as the aircraft 104b and the satellite 104c, which may include network entities on-board (e.g., one or more base stations) capable of communicating with other network elements (e.g., terrestrial base stations) and/or user equipment.

The base station 104a may generally include: a NodeB (NB), enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. The base station 104a may provide communications coverage for a respective geographic coverage area, which may sometimes be referred to as a cell, and which may overlap in some cases (e.g., a small cell may have a coverage area that overlaps the coverage area of a macro cell). A base station may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

The first wireless device 102 and/or the UE 104f may generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always-on (AON) devices, edge processing devices, or other similar devices. A UE may also be referred to more generally as a mobile device, a wireless device, a wireless communications device, a station (STA), a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and other terms.

In certain cases, the first wireless device 102 may control the transmit power used to emit RF signals in compliance with an RF exposure limit. RF exposure may be expressed in terms of a specific absorption rate (SAR), which measures energy absorption by human tissue per unit mass and may have units of watts per kilogram (W/kg). RF exposure may also be expressed in terms of power density (PD), which measures energy absorption per unit area and may have units of milliwatts per square centimeter (mW/cm²). In certain cases, a maximum permissible exposure (MPE) limit in terms of PD may be imposed for wireless communication devices using transmission frequencies above 6 GHz. Frequency bands of 24 GHz to 71 GHz are sometimes referred to as a “millimeter wave” (“mmW” or “mmWave”). The MPE limit is a regulatory metric for exposure based on area, e.g., an energy density limit defined as a number, X, watts per square meter (W/m2) averaged over a defined area and time-averaged over a frequency-dependent time window in order to prevent a human exposure hazard represented by a tissue temperature change. Certain RF exposure limits may be specified based on a maximum RF exposure metric (e.g., SAR or PD) averaged over a specified time window (e.g., 100 or 360 seconds for sub-6 GHz frequency bands or 2 seconds for 60 GHz bands).

SAR may be used to assess RF exposure for transmission frequencies less than 6 GHz, which cover wireless communication technologies such as 2G/3G (e.g., CDMA), 4G (e.g., E-UTRA), 5G (e.g., NR in sub-6 GHz bands), IEEE 802.11(e.g., a/b/g/n/ac), etc. PD may be used to assess RF exposure for transmission frequencies higher than 6 GHz, which cover wireless communication technologies such as IEEE 802.11ad, 802.11ay, 5G in mmWave bands, etc. Thus, different metrics may be used to assess RF exposure for different wireless communication technologies.

A wireless device (e.g., the first wireless device 102) may be capable of transmitting signals using multiple wireless communication technologies and/or frequency bands, and in some cases, capable of simultaneous transmission of such signals. For example, the wireless device may transmit signals using a first wireless communication technology operating at or below 6 GHZ (e.g., 3G, 4G, 5G, 802.11a/b/g/n/ac, etc.) and a second wireless communication technology operating above 6 GHz (e.g., mm Wave 5G in 24 to 60 GHz bands, IEEE 802.11ad or 802.11ay). In certain aspects, the wireless device may transmit signals using the first wireless communication technology (e.g., 3G, 4G, 5G in sub-6 GHz bands, IEEE 802.11ac, etc.) in which RF exposure may be measured in terms of SAR, and the second wireless communication technology (e.g., 5G in 24 to 71 GHz bands, IEEE 802.11ad, 802.11ay, etc.) in which RF exposure may be measured in terms of PD. As used herein, sub-6 GHz bands may include frequency bands of 300 megahertz (MHz) to 6,000 MHz in some examples, and may include bands in the 6,000 MHz and/or 7,000 MHz range in some examples.

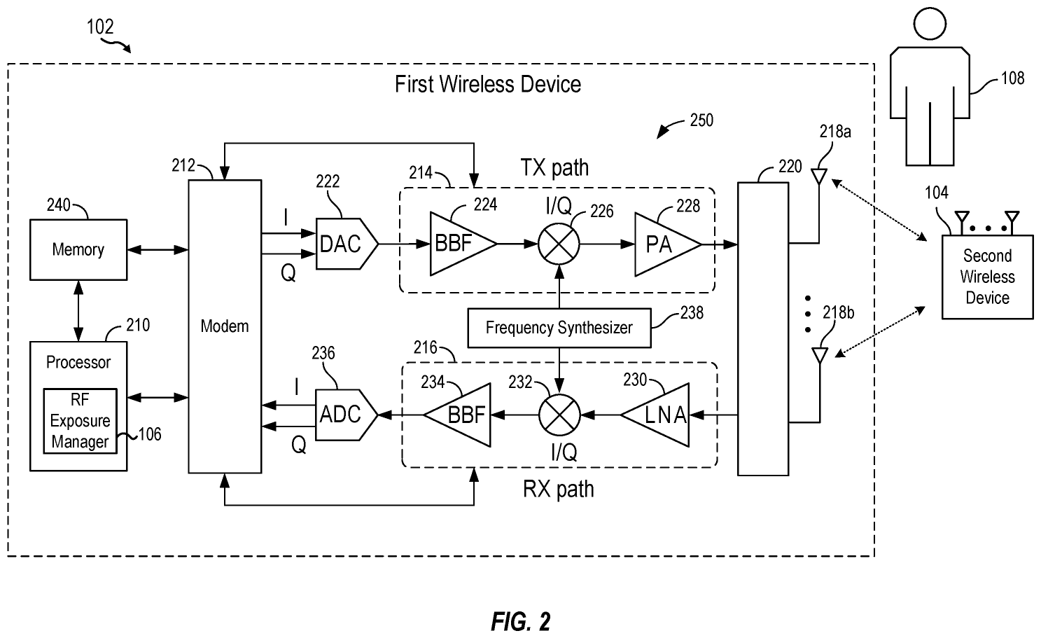

FIG. 2 illustrates example components of the first wireless device 102, which may be used to communicate with any of the second wireless device 104, in some cases, in proximity to human tissue as represented by the human 108.

The first wireless device 102 may be, or may include, a chip, system on chip (SoC), chipset, package or device that includes one or more modems 212. In some cases, the modem(s) 212 may include, for example, any of a WWAN modem (e.g., a modem configured to communicate via E-UTRA and/or 5G NR standards), a WLAN modem (e.g., a modem configured to communicate via 802.11 standards), a Bluetooth modem, a NTN modem, etc. In certain aspects, the first wireless device 102 also includes one or more radios (collectively “the radio(s) 250”). In some aspects, the first wireless device 102 further includes one or more processors, processing blocks, or processing elements (collectively “the processor 210”) and one or more memory blocks or elements (collectively “the memory 240”).

In certain aspects, the processor 210 may include a processor that is representative of an application processor that generates information (e.g., application data such as content requests) for transmission and/or receives information (e.g., requested content) via the modem 212. In some cases, the processor 210 may include a microprocessor associated with the modem 212, which may implement the RF exposure manager 106 and/or process any of certain protocol stack layers associated with a RAT. For example, the processor 210 may process any of an application layer, packet layer, WLAN protocol stack layers (e.g., a link or MAC layer), and/or WWAN protocol stack layers (e.g., a radio resource control (RRC) layer, a packet data convergence protocol (PDCP) layer, a radio link control (RLC) layer, and a MAC layer). In some cases, at least one of the modems 212 (e.g., the WWAN modem) may be in communication with one or more of the other modems 212 (e.g., the WLAN modem and/or Bluetooth modem). For example, the processor 210 may be representative of at least one of the modems 212 in communication with one or more of the other modems 212.

The modem 212 may include an intelligent hardware block or device such as an application-specific integrated circuit (ASIC), among other possibilities. The modem 212 may generally be configured to implement a physical (PHY) layer. For example, the modem 212 may be configured to modulate packets and to output the modulated packets to the radio(s) 250 for transmission over a wireless medium. The modem 212 is similarly configured to obtain modulated packets received by the radio(s) 250 and to demodulate the packets to provide demodulated packets. In addition to a modulator and a demodulator, the modem 212 may further include digital signal processing (DSP) circuitry, automatic gain control (AGC), a coder, a decoder, a multiplexer, and a demultiplexer (not shown).

As an example, while in a transmission mode, the modem 212 may obtain data from the processor 210. The data obtained from the processor 210 may be provided to a coder, which encodes the data to provide encoded bits. The encoded bits may be mapped to points in a modulation constellation (e.g., using a selected modulation and coding scheme) to provide modulated symbols. The modulated symbols may be mapped, for example, to spatial stream(s) or space-time streams. The modulated symbols may be multiplexed, transformed via an inverse fast Fourier transform (IFFT) block, and subsequently provided to DSP circuitry for transmit windowing and filtering. The digital signals may be provided to a digital-to-analog converter (DAC) 222. In certain aspects involving beamforming, the modulated symbols in the respective spatial streams may be precoded via a steering matrix prior to provision to the IFFT block.

The modem 212 may be coupled to the radio(s) 250 including a transmit (TX) path 214 (also known as a transmit chain) for transmitting signals via one or more antennas 218 and a receive (RX) path 216 (also known as a receive chain) for receiving signals via the antennas 218. When the TX path 214 and the RX path 216 share an antenna 218, the paths may be connected with the antenna via an interface 220, which may include any of various suitable RF devices, such as a switch, a duplexer, a diplexer, a multiplexer, and the like. As an example, the modem 212 may output digital in-phase (I) and/or quadrature (Q) baseband signals representative of the respective symbols to a DAC 222.

Receiving I or Q baseband analog signals from the DAC 222, the TX path 214 may include a baseband filter (BBF) 224, a mixer 226, and a power amplifier (PA) 228. The BBF 224 filters the baseband signals received from the DAC 222, and the mixer 226 mixes the filtered baseband signals with a transmit local oscillator (LO) signal to convert the baseband signal to a different frequency (e.g., upconvert from baseband to a radio frequency). In some aspects, the frequency conversion process produces the sum and difference frequencies between the LO frequency and the frequencies of the baseband signal. The sum and difference frequencies are referred to as the beat frequencies. Some beat frequencies are in the RF range, such that the signals output by the mixer 314 are typically RF signals, which may be amplified by the PA 228 before transmission by the antenna(s) 218. The antenna(s) 218 may emit RF signals, which may be received at the second wireless device 104. While one mixer 226 is illustrated, several mixers may be used to upconvert the filtered baseband signals to one or more intermediate frequencies and to thereafter upconvert the intermediate frequency signals to a frequency for transmission.

In some cases, the first wireless device 102 may communicate via multiple-input, multiple-output (MIMO) signals. The first wireless device 102 may transmit more than one signal via multiple antennas 218a, 218b (collectively “the antennas 218”) to the second wireless device 104 through multipath propagation. As an example, a first signal may be transmitted via the first antenna 218a, and a second signal may be transmitted via the second antenna 218b via a different propagation path than the first signal. The MIMO signals may facilitate increased communication link capacity (e.g., throughput) between the first wireless device 102 and the second wireless device 104.

The RX path 216 may include a low noise amplifier (LNA) 230, a mixer 232, and a baseband filter (BBF) 234. RF signals received via the antenna 218 (e.g., from the second wireless device 104) may be amplified by the LNA 230, and the mixer 232 (which may comprise one or several mixers) mixes the amplified RF signals with a receive local oscillator (LO) signal to convert the RF signal to a baseband frequency (e.g., downconvert). The baseband signals output by the mixer 232 may be filtered by the BBF 234 before being converted by an analog-to-digital converter (ADC) 236 to digital I or Q signals for digital signal processing. The modem 212 may receive the digital I or Q signals and further process the digital signals (e.g., demodulating the digital signals).

Certain transceivers may employ frequency synthesizers with a voltage-controlled oscillator (VCO) to generate a stable, tunable LO frequency with a particular tuning range. Thus, the transmit LO frequency may be produced by a frequency synthesizer 238, which may be buffered or amplified by an amplifier (not shown) before being mixed with the baseband signals in the mixer 226. Similarly, the receive LO frequency may be produced by the frequency synthesizer 238, which may be buffered or amplified by an amplifier (not shown) before being mixed with the RF signals in the mixer 232. Separate frequency synthesizers may be used for the TX path 214 and the RX path 216.

While in a reception mode, the modem 212 may obtain digitally converted signals via the ADC 236 and RX path 216. As an example, in the modem 212, digital signals may be provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to ultimately obtain a narrowband signal. The output of the DSP circuitry may be fed to the AGC, which is configured to use information extracted from the digital signals, for example, in one or more received training fields, to determine an appropriate gain. The output of the DSP circuitry also may be coupled with the demodulator, which is configured to extract modulated symbols from the signal and, for example, compute the logarithm likelihood ratios (LLRs) for each bit position of each subcarrier in each spatial stream. The demodulator may be coupled with the decoder, which may be configured to process the LLRs to provide decoded bits. The decoded bits from all of the spatial streams may be fed to the demultiplexer for demultiplexing. The demultiplexed bits may be descrambled and provided to a medium access control layer (e.g., the processor 210) for processing, evaluation, or interpretation.

The processor 210 and/or modem 212 may control the transmission of signals via the TX path 214 and/or reception of signals via the RX path 216. In some aspects, the processor 210 and/or modem 212 may be configured to perform various operations, such as those associated with the methods described herein. The processor 210 and/or the modem 212 may include a microcontroller, a microprocessor, an application processor, a baseband processor, a MAC processor, a neural network processor, a digital signal processor (DSP), an application specific integrated circuit (ASIC), a field programmable gate array (FPGA) or other programmable logic device (PLD), discrete gate or transistor logic, discrete hardware components, or any combination thereof. In some cases, aspects of the processor 210 may be integrated with (incorporated in and/or shared with) the modem 212, such as the RF exposure manager 106, a microcontroller, a microprocessor, a baseband processor, a medium access control (MAC) processor, a digital signal processor, etc. The memory 240 may store data and program codes (e.g., computer-readable instructions) for performing wireless communications as described herein. The memory 240 may be external to the processor 210 and/or the modem 212 (as illustrated) and/or incorporated therein. In certain cases, the RF exposure manager 106 (as implemented via the processor 210 and/or modem 212) may determine a transmit power (e.g., corresponding to certain levels of gain(s) applied to TX path 214 including the BBF 224, the mixer 226, and/or the PA 228) that complies with an RF exposure limit set by country-specific regulations and/or international guidelines (e.g., International Commission on Non-Ionizing Radiation Protection (ICNIRP) guidelines) as described herein.

FIG. 2 shows one reference example of a transceiver design. It will be appreciated that other transceiver designs or architectures may be applied in connection with aspects of the present disclosure. For example, while examples discussed herein utilize I and Q signals (e.g., quadrature modulation), those of skill in the art will understand that components of the transceiver may be configured to utilize any other suitable modulation, such as polar modulation. As another example, circuit blocks may be arranged differently from the configuration shown in FIG. 2, and/or other circuit blocks not shown in FIG. 2 may be implemented in addition to or instead of the blocks depicted.

In certain cases, compliance with an RF exposure limit may be performed as a time-averaged RF exposure evaluation within a specified running (moving) time window associated with the RF exposure limit. The RF exposure limit may specify a time-averaged RF exposure metric (e.g., SAR and/or PD) over the running time window. As an example, the Federal Communications Commission (FCC) specifies that certain SAR limits (general public exposure) are 0.08 W/kg, as averaged over the whole body, and a peak spatial-average SAR of 1.6 W/kg, averaged over any 1 gram of tissue (defined as a tissue volume in the shape of a cube) for sub-6 GHz bands, whereas certain PD limits are 1 mW/cm², as averaged over the whole body, and a peak spatial-average PD of 4 mW/cm², averaged over any 1 cm². The FCC also specifies the corresponding averaging time may be six minutes (360 seconds) for sub-6 GHz bands, whereas the averaging time may be 2 seconds for mmWave bands (e.g., 60 GHz frequency bands).

The RF exposure limit and/or corresponding averaging time window may vary based on the frequency band. In certain aspects, the RF exposure limit(s) and/or corresponding averaging time window(s), if applicable, may be specific to a particular geographic region or country, such as the United States, Canada, China, or European Union, as illustrative examples. In some cases, the RF exposure limit(s) may specify the maximum allowed RF exposure that can be encountered without time averaging. In such cases, the maximum allowed RF exposure may correspond to a maximum output or transmit power that can be used by the wireless device.

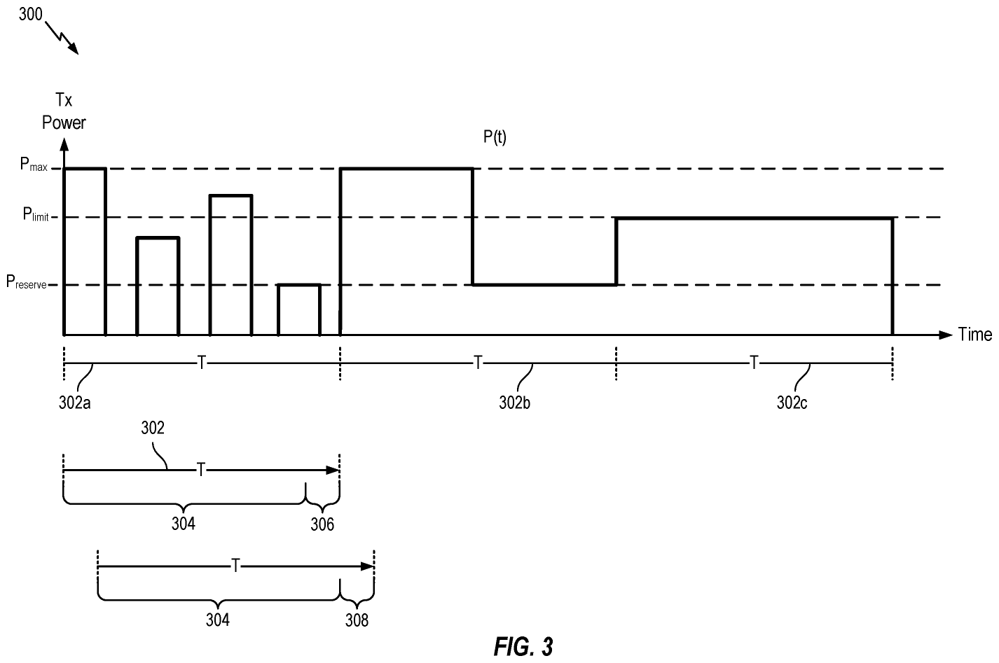

FIG. 3 is a graph 300 of a transmit power over time (P(t)) that varies over a running (e.g., rolling or moving) time window (T) associated with the RF exposure limit. The wireless device (e.g., the first wireless device 102) may evaluate RF exposure compliance over the running time window 302 (T) based on past RF exposure (e.g., a transmit power report) in a past time interval 304 of the time window 302 and a future time interval 306. The wireless device may determine the maximum allowed transmit power for the future time interval 306 that satisfies the time-averaged RF exposure limit based on the past RF exposure used in the past time interval 304. The wireless device may perform such a time-averaging evaluation as the time window 302 moves over time, such as in the next future time interval 308, where the past time interval 304 now includes the previous future time interval 306 (e.g., the future time interval 306).

The maximum time-averaged transmit power limit (Pₗᵢₘᵢₜ) represents the maximum transmit power the wireless device can transmit continuously for the duration of the running time window 302 (T) in compliance with the RF exposure limit. For example, the wireless device is transmitting continuously at Pₗᵢₘᵢₜ in the third time window 302c such that the time-averaged transmit power over the time window (e.g., the third time window 302c) is equal to Pₗᵢₘᵢₜ in compliance with the time-averaged RF exposure limit.

In certain cases, an instantaneous transmit power may exceed Pₗᵢₘᵢₜ in certain transmission occasions, for example, as shown in the first time window 302a and the second time window 302b. In some cases, the wireless device may transmit at Pₘₐₓ, which may be the maximum instantaneous transmit power supported by the wireless device, the maximum instantaneous transmit power the wireless device is capable of outputting, or the maximum instantaneous transmit power allowed by a standard or regulatory body (e.g., the maximum output power, P_{CMAX}). In some cases, the wireless device may transmit at a transmit power less than or equal to Pₗᵢₘᵢₜ in certain transmission occasions, for example, as shown in the first time window 302a.

In certain cases, a reserve power may be used to enable a continuous transmission within a time window (T) when transmitting above Pₗᵢₘᵢₜ in the time window or to enable a certain level of quality for certain transmissions. As shown in the second time window 302b, the transmit power may be backed off from Pₘₐₓ to a reserve power (Preserve) so that the wireless device can maintain a continuous transmission during the time window (e.g., maintain a radio connection with a receiving entity) in compliance with the time-averaged RF exposure limit. In the third time window 302c, the wireless device may increase the transmit power to Pₗᵢₘᵢₜ in compliance with the time-averaged RF exposure limit. In some cases, Pᵣₑₛₑᵣᵥₑ may allow for a certain level of transmission quality for certain transmissions (e.g., control signaling). Pᵣₑₛₑᵣᵥₑ may be used to reserve transmit power for at least a portion of the time window 302 for certain transmissions (e.g., control signaling). Pᵣₑₛₑᵣᵥₑ may also be referred to as a “control power level” or “control level.”

In the second time window 302b, the area between Pₘₐₓ and Pᵣₑₛₑᵣᵥₑ for the time duration of transmitting at Pₘₐₓ may be equal to the area between Pₗᵢₘᵢₜ and Pᵣₑₛₑᵣᵥₑ for the time window T, such that the area of transmit power (P(t)) in the second time window 302b is equal to the area of Pₗᵢₘᵢₜ for the time window T. Such an area may be considered using 100% of the energy (transmit power or exposure) to remain compliant with the time-averaged RF exposure limit. Without the reserve power Pᵣₑₛₑᵣᵥₑ, the transmitter may transmit at Pₘₐₓ for a portion of the time window with the transmitter turned off for the remainder of the time window to ensure compliance with the time-averaged RF exposure limit.

In some aspects, the wireless device may transmit at a power that is higher than Pₗᵢₘᵢₜ, but less than Pₘₐₓ in the time-average mode illustrated in the second time window 302b. While a single transmit burst is illustrated in the second time window 302b, it will be understood that the wireless device may instead utilize a plurality of transmit bursts within the time window (T), where the transmit bursts are separated by periods during which the transmit power is maintained at or below Pᵣₑₛₑᵣᵥₑ. Further, it will be understood that the transmit power of each transmit burst may vary (either within the burst and/or in comparison to other bursts), and that at least a portion of the burst may be transmitted at a power above Pₗᵢₘᵢₜ.

In certain aspects, the wireless device may transmit at a power less than or equal to a fixed power limit (e.g., Pₗᵢₘᵢₜ) without considering past exposure and/or past transmit powers in terms of a time-averaged RF exposure. For example, the wireless device may transmit at a power less than or equal to Pₗᵢₘᵢₜ using a look-up table (comprising one or more values of Pₗᵢₘᵢₜ depending on an RF exposure scenario). The look-up table may provide one or more values of Pₗᵢₘᵢₜ depending on the transmit frequency, transmit antenna, radio configuration (single-radio or multi-radio) and/or RF exposure scenario (e.g., a device state index corresponding to head exposure, body or torso exposure, extremity or hand exposure, and/or hotspot exposure) encountered by the wireless device. Examples of RF exposure scenarios include cases where the wireless device is emitting RF signals proximate to human tissue, such as a user's head, hand, or body (e.g., torso), or where the wireless device is being used as a hotspot away from human tissue. Therefore, the RF exposure can be managed as a time-averaged RF exposure evaluation (e.g., illustrated in FIG. 3), managed using a look-up table or flat or maximum value, or using another strategy or algorithm, where a particular process of managing the RF exposure may be referred to herein as an RF exposure control scheme.

For certain aspects, a wireless device may exhibit or be configured with a transmission duty cycle. The wireless device may determine transmit power level(s) and/or reserve power level(s) in compliance with the time-averaged RF exposure limit based on the duty cycle. The transmission duty cycle may be indicative of a share (e.g., 5 ms) of a specific period (e.g., 500 ms) in which the wireless device transmits RF signals. The duty cycle may be a ratio of the share to the specific period (e.g., 100 ms/500 ms), where the duty cycle may be represented as a number from zero to one. For example, in the first time window 302a, the duty cycle may be greater than 50% of the duration of the time window (T), whereas in the second time window 302b, the duty cycle may be equal to 100% of the duration of the time window (T).

In certain cases, the duty cycle may be standardized (e.g., predetermined) with a specific RAT and/or vary over time, for example, due to changes in radio conditions, mobility, and/or user behavior. As an example, certain RATs may specify the uplink duty cycle in the form of a time division duplexing (TDD) configuration, such as a TDD uplink-downlink (UL-DL) slot pattern in 5G NR or similar TDD patterns in E-UTRA or UMTS. In 5G NR, the TDD UL-DL slot pattern may specify the number of uplink slots and corresponding position in time associated with the uplink slots in a sequence of slots, such that the total number of uplink slots with respect to the total number of slots in the sequence is indicative of the duty cycle. In certain aspects, the duty cycle may correspond to the actual duration for past transmissions scheduled or used, for example, within the TDD UL-DL slot pattern. For example, although the wireless device may be configured with a TDD UL-DL slot pattern, the wireless device may use a portion or subset of the UL slots for transmitting RF signals. Thus, the duty cycle for the wireless device may be less than the maximum available duty cycle corresponding to the TDD UL-DL slot pattern.

In some cases, a controller (e.g., a WWAN modem) may control the RF exposure exhibited by WWAN radios in addition to other radios (e.g., WLAN radio(s) and/or Bluetooth radio(s)).

Example Selection of a Controller and/or Calculations for Radio Frequency Exposure Compliance

Aspects of the present disclosure provide apparatus and methods for selection of a controller for RF exposure compliance. The selection of a controller among multiple controllers (e.g., modems and/or processors associated with any of various radios and/or RATs) may be based on any of various suitable criteria, where the criteria may include traffic activity, a duty cycle, a processing load, a quality of service (QOS), one or more radio conditions, a priority, one or more capabilities of a controller, or any combination thereof. The selection of the controller may be in response to detecting the active primary controller (e.g., the WWAN modem) being in a particular state (e.g., airplane mode, sleep mode, or a low power state).

The apparatus and methods for selection of a controller described herein may provide various advantages. For example, selection of the controller may allow certain radios to transmit RF signals in compliance with RF exposure limits, preventing what is deemed to be harmful or undesirable exposure to human tissues. In certain cases, selection of the controller may allow certain radios to improve wireless communication performance (e.g., increased throughput, decreased latency, and/or increased transmission range), for example, due to a centralized time-averaging RF exposure evaluation. The transmit power limits may be dynamically allocated across the radios to allow for high transmit powers.

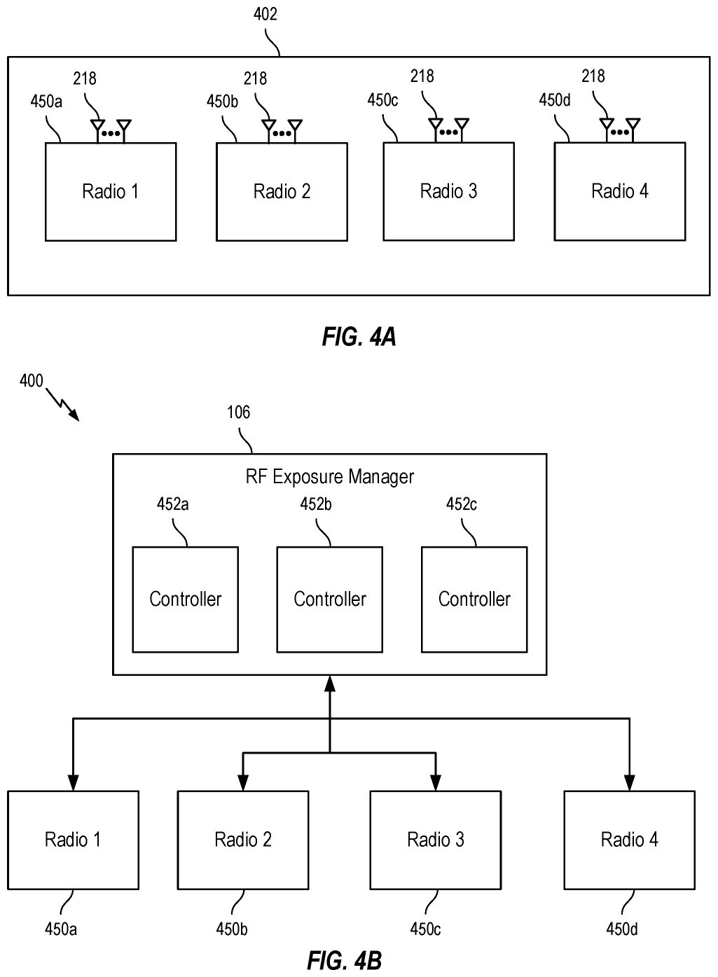

FIG. 4A is a diagram illustrating an example wireless device 402 (e.g., the first wireless device 102) having multiple radios 450a-450d (collectively, “the radios 450”). The radios 450 may be similar to the radio(s) 250 of the first wireless device 102 depicted in FIG. 2. In the example depicted in FIG. 4A, the radios 450a-450d may be associated with any of various RATs and/or frequency bands. For example, the radio 450a (or radio 1) may communicate via WWAN RAT(s) (e.g., E-UTRA and/or 5G NR) in sub-6 GHz frequency bands. The radio 450b (or radio 2) may communicate via WWAN RAT(s) (e.g., 5G NR) in mmWave frequency bands. The radio 450c (or radio 3) may communicate via WLAN RAT(s) in sub-6 GHZ (e.g., 2.4 GHz, 5 GHZ, and/or 6 GHZ) frequency bands. The radio 450d (or radio 4) may communicate via short-range communications (e.g., Bluetooth) in a 2.4 GHz frequency band. While this example shows a wireless device having four radios, a wireless device may have any number of radios for wireless communications, such as a radio per frequency band associated with WWAN and/or WLAN communications, a radio per RAT, or a radio capable of communicating via multiple RATs, as illustrative, non-limiting examples. Further, while the radios are illustrated as being separate, two or more of the radios may share components or circuitry. For example, portions of a signal path may be shared. The shared portion may include a shared or common mixer, filter, amplifier, and/or ADC or DAC, etc.

FIG. 4B is a diagram illustrating an example logical architecture 400 for controlling the transmit power (and hence, the RF exposure) associated with one or more radios (e.g., the radios 450a-450d) of a wireless device (e.g., the wireless device 404). The RF exposure manager 106 may operate as a primary controller for controlling the RF exposure associated with the radios 450a-450d. The primary controller may be a central controller (e.g., the outer loop) for determining the maximum allowed transmit powers that can be used for a future time interval based on past transmit powers associated with all of the radios 450a-450d. For example, the RF exposure manager 106 may periodically (e.g., every 500 milliseconds) receive certain information from the radios 450a-450d, where each of the radios 450a-450d may be representative of a particular inner loop providing the information to the RF exposure manager 106. The information may include, for example, a requested transmit power or exposure margin for a future time interval (e.g., the time interval 306, 308) and/or past transmit power history associated with a time interval (e.g., the past time interval 304) and/or averaging time window (e.g., the time window 302) or indication of whether a radio was on (active) or transmitting during the time interval and/or averaging time window. The RF exposure manager 106 may periodically (e.g., every 500 milliseconds) provide each of the radios with an RF exposure margin or maximum allowed transmit power for a future time interval (e.g., the future time interval 306, 308).

The primary controller may include any of a number of controllers (e.g., the controller 452a, the controller 452b, and/or the controller 452c). The controller 452a may represent the WWAN modem, the controller 452b may represent the WLAN modem, and the controller 452c may represent the Bluetooth modem, for example. Thus, while the controllers 452 are illustrated separate from the radios 450, the controllers 452 and/or certain functionality thereof may be included within or integrated with respective radios 450. Similarly, functionality described above as pertaining to an “inner loop” or operation of a radio 450 may be implemented by an associated controller 452, which for example may be included in a modem (e.g., the modem 212 or a separate modem associated with a respective radio), a processor (e.g., the processor 210 or a separate processor associated with a respective radio), and/or the RF exposure manager 106. The controllers 452 are illustrated as being within the RF exposure manager 106, but one or more of the controllers 452 may be implemented external to the RF exposure manager 106. Further, while certain of the controllers 452 are described as being associated with or configured to implement functionality of a particular radio and/or RAT, one or more of the controllers 452 may be agnostic with respect to radios and/or RATs, and/or may be shared by multiple radios. For example, a controller 452 may be included in an applications processor. In some examples, information (e.g., exposure history) that may be used by multiple radios or that might be beneficial to maintain when the primary controller is switched from one controller to another may be stored in a common location or in a manner which is substantially continuously accessible (e.g., not affected by duty cycles, airplane mode, etc. of various radios). For example, such information may be stored in a memory (e.g., the memory 240) if the memory is accessible to multiple controllers and/or may be stored in a memory associated with an applications processor.

The controller 452a may serve as the primary controller by default. In some cases, when the controller 452a is unable to serve as the primary controller (e.g., the controller 452a switches to an idle mode, sleep mode, and/or a low power state, for example, due to the wireless device switching to airplane mode; encounters an exception or error; or is instructed to restart or otherwise be unavailable for a period), the wireless device may select a primary controller among the controller 452b and/or the controller 452c. One of the controllers 452b, 452c associated with the RF exposure manager 106 may assume the responsibility of the primary controller, for example, based on one or more criteria. The criteria for selecting the primary controller among the other controllers 452b, 452c may include, for example, the traffic activity associated with the controller, a duty cycle associated with the controller, a processing load associated with the controller, a quality of service associated with the controller, one or more radio conditions associated with the controller, a priority associated with the controller, and/or one or more capabilities associated with the controller.

In some cases, traffic activity, duty cycle, processing load, quality of service, and/or radio conditions associated with a controller may indicate whether the controller assumes control as the primary controller. For example, suppose the controller 452b is experiencing greater traffic activity (or duty cycle) than the controller 452c. The traffic activity associated with the controller 452b may indicate that the controller 452b will have an increased processing load compared to the controller 452c. In such a case, the controller 452c may assume control as the primary controller to ensure the processing capabilities of the controller 452b are not compromised or overloaded. In other cases, the controller 452b may assume control as the primary controller (when the controller 452b has sufficient processing capabilities) to ensure that transmission power can be maximized during the greater traffic activity.

In certain cases, the controllers may be associated with a priority, where the highest priority controller may assume control as the primary controller. The priorities may be preconfigured or determined a priori, or may be dynamically configured, for example, based on an application or type of communication associated with a radio corresponding to a controller.

The capabilities may include the processing capabilities associated with the controller or the capability to communicate with other radios. The processing capabilities may include, for example, the processing resources associated with the controller including memory size and/or frequency, bus size and/or frequency, number of processor cores and/or frequency, etc. The processing capabilities may include the capability to access memory (e.g., non-volatile memory) to store power report(s) and run the RF exposure control algorithm for multiple radios, for example. The communication capabilities may include, for example, a controller having communication routes or interfaces to other radios (or the most number of communication routes to other radios) to facilitate the exchange of information (e.g., the power reports from radios and exposure margins to radios and/or indications of whether another radio is on (active) and/or transmitting).

In certain aspects, a controller may take control of its own power limit and operate in a standalone manner (or mode) in response to the primary controller being in a particular state (e.g., idle mode, inactive, sleep mode, low power state, etc.). For example, when the controller 452a switches to a sleep or idle mode (e.g., due to the wireless device switching to airplane mode), the controller 452b may operate in a standalone mode controlling the RF exposure associated with the radio 450c, and in some cases, the controller 452c may operate in standalone mode controlling the RF exposure associated with the radio 450d. The controller 452b, 452c may perform a time-averaged RF exposure evaluation to determine the transmit powers in compliance with the RF exposure limit, for example, as described herein with respect to FIG. 3. Individual RATs may perform a standalone time-averaged power control at a design target power (e.g., an RF exposure margin) set for each RAT so that the compliance is met by all of the RATs. The cumulative target powers associated with the RATs may satisfy the RF exposure limit. A design target power (e.g., RF exposure margin) may be allocated to every RAT in a static manner that ensures compliance with the RF exposure limit. For example, the controller 452b may be allocated 60% of the RF exposure margin for a given time window, and the controller 452c may be allocated 40% of the RF exposure margin for the time window. In some examples, a subset of the controllers may operate in a standalone mode, and a separate subset may operate under control of a new primary controller.

For certain aspects, the primary controller (e.g., the controller 452a) may provide the other controllers 452b, 452c with certain information. For example, the primary controller may instruct the other controllers to use specific RF exposure calculations—for example, an RF exposure compliance algorithm (e.g., time-averaging or a particular maximum transmit power) with a preset parameter (e.g., RF exposure margin or transmit power level)—to control each of the other controllers' own power limits in a standalone manner. The RF exposure compliance algorithm may be the same or different among the controllers. For example, the complexity of the algorithms or calculations may be considered when instructing the controllers. It may be unnecessary for certain controllers to evaluate the same number of criteria, and/or the controllers may have varying capabilities.

The primary controller may indicate to the other controllers that the primary controller is going to a state where the primary controller can no longer operate as the primary controller (for a particular or indefinite time). In response to such an indication, each of the other controllers may assume control of its own transmit power limit and operate in a standalone manner, and/or may operate according to specific calculations assigned previously or instructed by the primary controller.

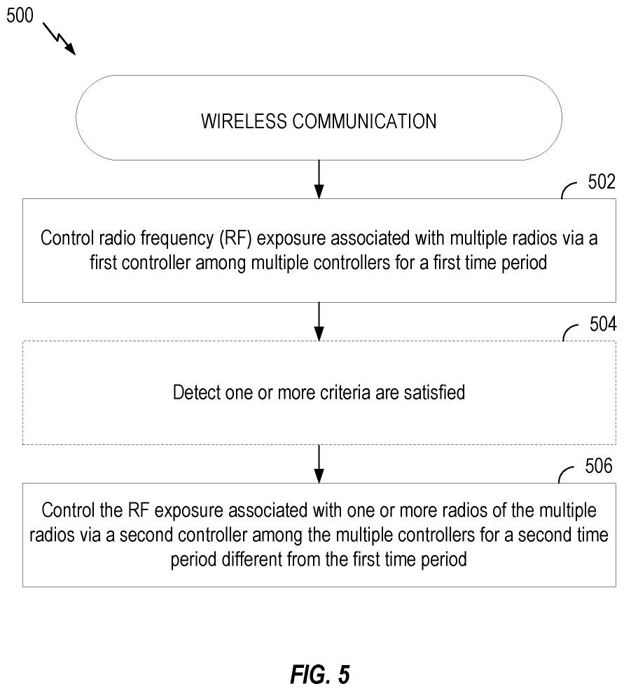

FIG. 5 is a flow diagram illustrating example operations 500 for wireless communication. The operations 500 may be performed, for example, by a wireless device (e.g., the first wireless device 102 in the wireless communication system 100). The operations 500 may be implemented as software components that are executed and run on one or more processors (e.g., the processor 210 and/or the modem 212 of FIG. 2). Further, the transmission and/or reception of signals by the wireless device in the operations 500 may be enabled, for example, by one or more antennas (e.g., antennas 218 of FIG. 2). In certain aspects, the transmission and/or reception of signals by the wireless device may be implemented via a bus interface of one or more processors (e.g., the processor 210 and/or the modem 212) obtaining and/or outputting signals for reception or transmission.

The operations 500 may optionally begin, at block 502, where the wireless device may control RF exposure associated with multiple radios (e.g., the radios 450a-450d or the radio(s) 250) via a first controller (e.g., the controller 452a) among multiple controllers (e.g., the controller 452a-452c) for a first time period. For example, the first controller may operate as a default primary controller for the first time period. At least some of the multiple radios are associated with different RATs (e.g., WWAN, WLAN, and/or short-range communications).

At block 504, the wireless device may detect one or more criteria are satisfied. In some cases, the criteria may include detecting that the first controller is in a particular state (e.g., an incommunicable state). The one or more criteria may include traffic activity associated with a second controller (e.g., controller 452b or controller 452c); a duty cycle associated with the second controller; a processing load associated with the second controller; a quality of service associated with the second controller; one or more radio conditions associated with the second controller; a priority associated with the second controller; one or more capabilities (e.g., processing or inter-controller communications) associated with the second controller; or any combination thereof.

At block 506, the wireless device may control the RF exposure associated with one or more radios (e.g., the radios 450c-d) of the multiple radios via a second controller (e.g., the controller 452b or controller 452c) among the multiple controllers for a second time period different from the first time period. For example, the wireless device may control the RF exposure associated with the one or more radios in response to detecting the one or more criteria being satisfied and/or detecting the first controller being in a particular state (e.g., an incommunicable state), as described herein.

To detect the one or more criteria are satisfied, the wireless device may compare the one or more criteria associated with the second controller to one or more criteria associated with another controller (e.g., the controller 452c or controller 452b) among the multiple controllers or to a threshold. The one or more criteria are satisfied when the comparison indicates that the second controller should operate as a primary controller, for example, as described herein with respect to FIG. 4B. Operating as a primary controller may include the second controller assuming control of the RF exposure associated with multiple RATs. In certain aspects, there may be an order of precedence (or priority) associated with the satisfied criteria in case where there is a conflict among multiple controllers based on individual criteria and/or where multiple criteria are satisfied for a single controller. For example, a controller having the processing resources or capabilities to serve as a primary controller may take precedence over another controller having a low traffic load conducive for serving as the primary controller. In some cases, the wireless device may apply a precedence of a first criterion (e.g., processing capabilities and/or inter-controller communications) over a second criterion (e.g., a duty cycle or traffic activity). The first controller may evaluate the criteria and identify the second controller before going offline. In other examples, another component of the wireless device (e.g., a form of coexistence manager, a processor (such as the processor 210)) may evaluate the criteria and/or identify the second controller.

In certain aspects, the second controller may assume control when the first controller is in a particular state (e.g., airplane mode). For example, when the second controller detects that the first controller is offline (or in another particular state), the second controller may issue a notification to the other controllers or begin sending transmission powers or margins without being instructed by the primary controller or coexistence manager.

The wireless device may control the RF exposure associated with the one or more radios in response to detecting the first controller being in the particular state. The particular state includes: the first controller being offline (e.g., airplane mode), the first controller being in a low power state, the first controller being incommunicable for a particular duration, the first controller being unresponsive (e.g., during a boot process or an initialization process), or any combination thereof.

For certain aspects, the second controller may operate in a standalone mode without controlling the RF exposure associated with other RATs. The one or more radios consist of one or more radios associated with the second controller. In some examples, standalone mode is used when the second controller does not meet the specifications or criteria described above for controlling and/or communicating with other controllers. In some examples, standalone mode is used when the second controller is in a startup condition or cycling or otherwise busy with other tasks. In some examples, standalone mode is used when the wireless device or the second controller determines that a likely benefit or performance outcome does not outweigh the costs of controlling the other radio(s) (e.g., due to a specific processing power or capability, etc.) and/or or that certain (or all) radios are not likely to benefit from being able to transmit in high power bursts under time averaging. For example, if one or more radios are likely to transmit at a roughly constant power, then it may not be necessary to control such radios under a time-averaging algorithm. In another example, if a radio is not likely to use the power allocated to this radio, then that excess power may be wasted, and this may weigh in favor of controlling that radio (e.g., in a standalone mode or by the second controller) under time averaging.

In certain aspects, the primary controller may provide the other controllers with certain information (e.g., an indication to select a substitute primary controller or transmit power limits). For example, the wireless device may obtain, from the first controller at the second controller, information associated with the second controller operating as a primary controller. To control the RF exposure associated with the one or more radios at block 506, the wireless device may control the RF exposure associated with the one or more radios based at least in part on the information. The information may include an indication for the second controller to operate as the primary controller when the first controller is (or expected to be) in a particular state, an indication of when the second controller may (or should or could) begin operating as the primary controller, an indication of when the second controller may stop operating as the primary controller, a time duration for the second controller to operate as the primary controller, an indication of which radios for the secondary controller to manage as the primary controller, RF exposure information associated with the one or more radios, or any combination thereof. The RF exposure information may include target transmit powers for each of the radios, RF exposure budget or margin for each of the radios, RF exposure history (e.g., or corresponding transmit power history), reserve power levels for each of the radios, etc.

The first controller may resume control of the RF exposure associated with the radios in response to one or more criteria being satisfied. For example, the first controller may resume control after a particular duration of time occurs or a timer expires. In some cases, the first controller may resume control of the RF exposure in response to the first controller transitioning to a different state, for example, coming back online from being in an idle mode or sleep mode. The transition from the second controller to the first controller may occur automatically in response to the first controller transitioning to a different state. In some cases, the second controller may periodically monitor if the first controller is available to resume control of the RF exposure. For example, the active primary controller may periodically evaluate if there is another controller available to operate as the primary controller, and/or if the other controller satisfies the criteria to operate as the primary controller. For example, every couple of time windows (or another time duration), the wireless device may evaluate the criteria described herein to determine whether to switch primary controllers.

For certain aspects, controlling the RF exposure associated with radios may include performing a centralized architecture (e.g., with an outer loop and inner loop) as described herein with respect to FIG. 4B. For example, when the second controller is acting as the primary controller, the wireless device may obtain, at the second controller, RF exposure information associated with the one or more radios, where the RF exposure information may include a transmit power report, for example, associated with a past time interval (e.g., the past time interval 304) and/or an indication of whether the one or more radios were transmitting during the past time interval. The wireless device may determine, for at least one of the radios, a maximum allowed transmit power for a time interval (e.g., the future time interval 306) based at least in part on the RF exposure information associated with the radios. The wireless device may provide an indication of the maximum allowed transmit power to a third controller (e.g., the controller 452c or controller 452b) among the plurality of controllers. The third controller may determine a transmit power for one or more radios associated with the third controller based on the maximum allowed transmit power.

In certain aspects, the second controller (and/or other controllers) may operate based on the calculations and/or algorithm assigned by the first controller. For example, the first controller may instruct the other controllers to use specific RF exposure calculations—for example, an RF exposure compliance algorithm (e.g., time-averaging or a particular maximum transmit power) with a preset parameter (e.g., RF exposure margin or transmit power level)—to control each of the other controllers' own power limits in a standalone mode or manner. The second controller may control the RF exposure associated with its radios in response to the instruction(s) obtained from the first controller.

Aspects of the present disclosure may be applied to any of various wireless communication devices (wireless devices) that may emit RF signals causing exposure to human tissue, such as a base station and/or a CPE, performing the RF exposure compliance described herein.

### Example Communications Device

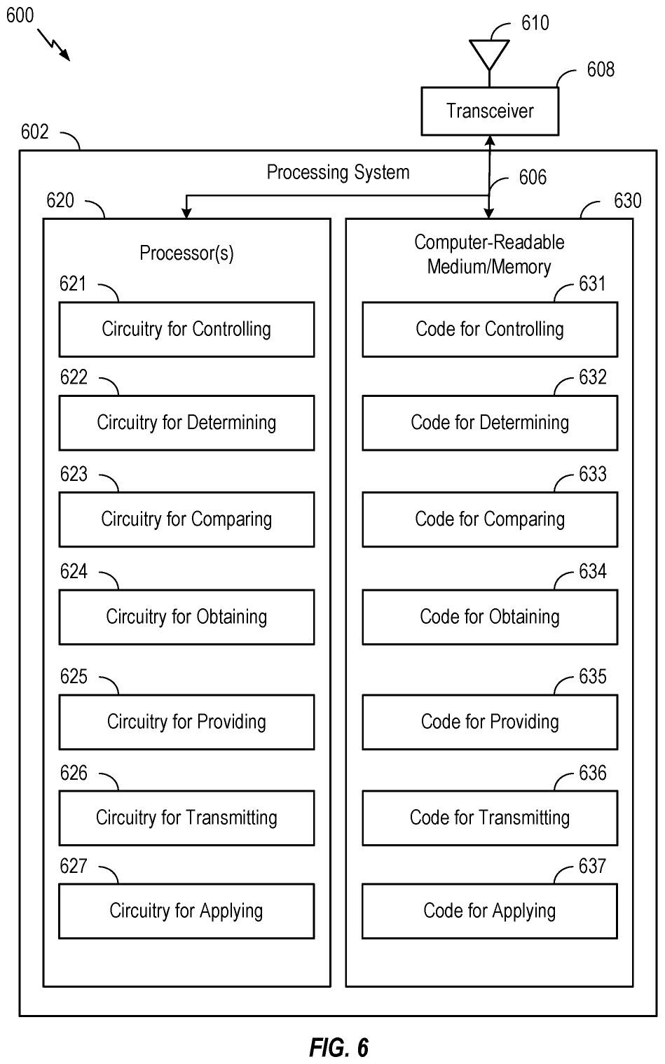

FIG. 6 depicts aspects of an example communications device 600. In some aspects, communications device 600 is a wireless communication device, such as the first wireless device 102 described above with respect to FIGS. 1 and 2.

The communications device 600 includes a processing system 602 coupled to a transceiver 608 (e.g., a transmitter and/or a receiver). The transceiver 608 is configured to transmit and receive signals for the communications device 600 via an antenna 610, such as the various signals as described herein. The processing system 602 may be configured to perform processing functions for the communications device 600, including processing signals received and/or to be transmitted by the communications device 600.

The processing system 602 includes one or more processors 620. In various aspects, the one or more processors 620 may be representative of any of the processor 210 and/or the modem 212, as described with respect to FIG. 2. The one or more processors 620 are coupled to a computer-readable medium/memory 630 via a bus 606. In certain aspects, the computer-readable medium/memory 630 is configured to store instructions (e.g., computer-executable code) that when executed by the one or more processors 620, cause the one or more processors 620 to perform the operations 500 described with respect to FIG. 5, or any aspect related to the operations described herein. Note that reference to a processor performing a function of communications device 600 may include one or more processors performing that function of communications device 600.

In the depicted example, computer-readable medium/memory 630 stores code (e.g., executable instructions) for controlling 631 (including code for operating), code for determining 632 (including code for detecting), code for comparing 633, code for obtaining 634, code for providing 635, code for transmitting 636, and code for applying 637. Processing of the code 631-637 may cause the communications device 600 to perform the operations 500 described with respect to FIG. 5, or any aspect related to operations described herein.

The one or more processors 620 include circuitry configured to implement (e.g., execute) the code stored in the computer-readable medium/memory 630, including circuitry for controlling 621 (including circuitry for operating), circuitry for determining 622 (including circuitry for detecting), circuitry for comparing 623, circuitry for obtaining 624, circuitry for providing 625, circuitry for transmitting 626, and circuitry for applying 627. Processing with circuitry 621-627 may cause the communications device 600 to perform the operations 500 described with respect to FIG. 5, or any aspect related to operations described herein.

Various components of the communications device 600 may provide means for performing the operations 500 described with respect to FIG. 5, or any aspect related to operations described herein. For example, means for transmitting, sending or outputting for transmission may include the TX path 214 and/or antenna(s) 218 of the first wireless device 102 illustrated in FIG. 2 and/or transceiver 608 and antenna 610 of the communications device 600 in FIG. 6. Means for receiving or obtaining may include the RX path 216 and/or antenna(s) 218 of the first wireless device 102 illustrated in FIG. 2, and/or transceiver 608 and antenna 610 of the communications device 600 in FIG. 6. Means for controlling, means for operating, means for determining, means for detecting, means for comparing, means for applying, means for obtaining, and/or means for providing may include a processor, such as the processor 210 and/or modem 212 depicted in FIG. 2 and/or the processor(s) 620 in FIG. 6.

### Example Aspects

Implementation examples are described in the following numbered clauses:

Aspect 1: A method of wireless communication by a wireless device, comprising: controlling radio frequency (RF) exposure associated with a plurality of radios via a first controller among a plurality of controllers for a first time period; and controlling the RF exposure associated with one or more radios of the plurality of radios via a second controller among the plurality of controllers for a second time period different from the first time period.

Aspect 2: The method of Aspect 1, wherein controlling the RF exposure associated with the one or more radios comprises controlling the RF exposure associated with the one or more the radios in response to detecting one or more criteria being satisfied.

Aspect 3: The method of Aspect 2, wherein the one or more criteria include: traffic activity associated with the second controller; a duty cycle associated with the second controller; a processing load associated with the second controller; a quality of service associated with the second controller; one or more radio conditions associated with the second controller; a priority associated with the second controller; one or more capabilities associated with the second controller; or any combination thereof.

Aspect 4: The method according to any of Aspects 2-3, wherein detecting the one or more criteria are satisfied comprises comparing the one or more criteria associated with the second controller to one or more criteria associated with another controller among the plurality of controllers or to a threshold, and wherein the one or more criteria are satisfied when the comparison indicates that the second controller should operate as a primary controller.

Aspect 5: The method according to any of Aspects 2-4, wherein detecting the one or more criteria are satisfied comprises applying a precedence of a first criterion over a second criterion.

Aspect 6: The method according to any of Aspects 1-5, wherein controlling the RF exposure associated with the one or more radios comprises controlling the RF exposure associated with the one or more radios in response to detecting the first controller being in a particular state.

Aspect 7: The method of Aspect 6, wherein the particular state includes: the first controller being offline; the first controller being in a low power state; the first controller being incommunicable for a particular duration; the first controller being unresponsive, or any combination thereof.

Aspect 8: The method according to any of Aspects 1-7, wherein at least some of the plurality of radios are associated with different radio access technologies.

Aspect 9: The method according to any of Aspects 1-8, wherein the one or more radios consist of one or more radios associated with the second controller.

Aspect 10: The method according to any of Aspects 1-9, wherein controlling the RF exposure via the second controller comprises operating the second controller in a standalone mode.

Aspect 11: The method according to any of Aspects 1-10, further comprising: obtaining, from the first controller at the second controller, information associated with the second controller operating as a primary controller, wherein controlling the RF exposure associated with the one or more radios comprises controlling the RF exposure associated with the one or more radios based at least in part on the information.

Aspect 12: The method of Aspect 11, wherein the information includes: an indication for the second controller to operate as the primary controller when the first controller is in a particular state; RF exposure information associated with the one or more radios; or any combination thereof.

Aspect 13: The method of Aspect 12, wherein the RF exposure information includes: one or more target powers associated with the one or more radios; one or more RF exposure budgets associated with the one or more radios; an RF exposure history associated with the one or more radios; a transmit power history associated with the one or more radios; one or more reserve powers associated with the one or more radios; or any combination thereof.

Aspect 14: The method according to any of Aspects 1-13, wherein controlling the RF exposure associated with the one or more radios comprises: obtaining RF exposure information associated with the one or more radios; determining, for at least one of the radios, a maximum allowed transmit power for a time interval based at least in part on the RF exposure information; and providing an indication of the maximum allowed transmit power to a third controller among the plurality of controllers.

Aspect 15: An apparatus, comprising: one or more memories collectively storing executable instructions; and one or more processors coupled to the one or more memories, the one or more processors being collectively configured to execute the executable instructions to cause the apparatus to perform a method in accordance with any of Aspects 1-14.

Aspect 16: An apparatus, comprising means for performing a method in accordance with any of Aspects 1-14.

Aspect 17: A non-transitory computer-readable medium comprising computer-executable instructions that, when executed by one or more processors of a processing system, cause the processing system to perform a method in accordance with any of Aspects 1-14.

Aspect 18: A computer program product embodied on a computer-readable storage medium comprising code for performing a method in accordance with any of Aspects 1-14.

### Additional Considerations

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, “a processor,” “at least one processor,” or “one or more processors” generally refer to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refer to a single memory configured to store data and/or instructions or multiple memories configured to collectively store data and/or instructions.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, identifying, searching, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. A hardware module may include several electrical elements (e.g., one or more dies and/or other components) packaged together.

The various illustrative logical blocks, modules and circuits described in connection with the present disclosure may be implemented or performed with a general purpose processor, a digital signal processor (DSP), a neural network processor, a system on chip (SoC), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a UE (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer-readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (random access memory), flash memory, ROM (read-only memory), PROM (programmable read-only memory), EPROM (erasable programmable read-only memory), EEPROM (electrically erasable programmable read-only memory), registers, magnetic disks, optical disks, hard drives, or any other suitable non-transitory storage medium, or any combination thereof. The machine-readable media may be embodied in a computer program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein (e.g., instructions for performing the operations described herein and illustrated in FIG. 5).

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, or other physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. A method of wireless communication by a wireless device, comprising:
controlling radio frequency (RF) exposure associated with a plurality of radios via a first controller among a plurality of controllers for a first time period; and
controlling the RF exposure associated with one or more radios of the plurality of radios via a second controller among the plurality of controllers for a second time period different from the first time period.

2. The method of claim 1, wherein controlling the RF exposure associated with the one or more radios comprises controlling the RF exposure associated with the one or more radios in response to detecting one or more criteria being satisfied.

3. The method of claim 2, wherein the one or more criteria include:
traffic activity associated with the second controller;
a duty cycle associated with the second controller;
a processing load associated with the second controller;
a quality of service associated with the second controller;
one or more radio conditions associated with the second controller;
a priority associated with the second controller;
one or more capabilities associated with the second controller; or
any combination thereof.

4. The method of claim 2, wherein detecting the one or more criteria are satisfied comprises comparing the one or more criteria associated with the second controller to one or more criteria associated with another controller among the plurality of controllers or to a threshold, and wherein the one or more criteria are satisfied when the comparison indicates that the second controller should operate as a primary controller.

5. The method of claim 2, wherein detecting the one or more criteria are satisfied comprises applying a precedence of a first criterion over a second criterion.

6. The method of claim 1, wherein controlling the RF exposure associated with the one or more radios comprises controlling the RF exposure associated with the one or more radios in response to detecting the first controller being in a particular state.

7. The method of claim 6, wherein the particular state includes:
the first controller being offline;
the first controller being in a low power state;
the first controller being incommunicable for a particular duration;
the first controller being unresponsive; or
any combination thereof.

8. The method of claim 1, wherein at least some of the plurality of radios are associated with different radio access technologies.

9. The method of claim 1, wherein the one or more radios consist of one or more radios associated with the second controller.

10. The method of claim 1, wherein controlling the RF exposure via the second controller comprises operating the second controller in a standalone mode.

11. The method of claim 1, further comprising obtaining, from the first controller at the second controller, information associated with the second controller operating as a primary controller, wherein controlling the RF exposure associated with the one or more radios comprises controlling the RF exposure associated with the one or more radios based at least in part on the information.

12. The method of claim 11, wherein the information includes:
an indication for the second controller to operate as the primary controller when the first controller is in a particular state;
RF exposure information associated with the one or more radios; or
any combination thereof.

13. The method of claim 12, wherein the RF exposure information includes:
one or more target powers associated with the one or more radios;
one or more RF exposure budgets associated with the one or more radios;
an RF exposure history associated with the one or more radios;
a transmit power history associated with the one or more radios;
one or more reserve powers associated with the one or more radios; or
any combination thereof.

14. The method of claim 1, wherein controlling the RF exposure associated with the one or more radios comprises:
obtaining RF exposure information associated with the one or more radios;
determining, for at least one of the radios, a maximum allowed transmit power for a time interval based at least in part on the RF exposure information; and
providing an indication of the maximum allowed transmit power to a third controller among the plurality of controllers.

15. An apparatus for wireless communication, comprising:
one or more memories collectively storing executable instructions; and
one or more processors coupled to the one or more memories, the one or more processors being collectively configured to execute the executable instructions to cause the apparatus to:
control radio frequency (RF) exposure associated with a plurality of radios via a first controller among a plurality of controllers for a first time period; and
control the RF exposure associated with one or more radios of the plurality of radios via a second controller among the plurality of controllers for a second time period different from the first time period.

16. The apparatus of claim 15, wherein, to control the RF exposure associated with the one or more radios, the one or more processors are collectively configured to execute the executable instructions to cause the apparatus to control the RF exposure associated with the one or more radios in response to detecting one or more criteria being satisfied.

17. The apparatus of claim 16, wherein the one or more criteria include:
traffic activity associated with the second controller;
a duty cycle associated with the second controller;
a processing load associated with the second controller;
a quality of service associated with the second controller;
one or more radio conditions associated with the second controller;
a priority associated with the second controller;
one or more capabilities associated with the second controller; or
any combination thereof.

18. The apparatus of claim 15, wherein, to control the RF exposure associated with the one or more radios, the one or more processors are collectively configured to execute the executable instructions to cause the apparatus to control the RF exposure associated with the one or more radios in response to detecting the first controller being in a particular state.

19. The apparatus of claim 18, wherein the particular state includes:
the first controller being offline;
the first controller being in a low power state;
the first controller being incommunicable for a particular duration;
the first controller being unresponsive; or
any combination thereof.

20. An apparatus for wireless communication, comprising:
means for controlling radio frequency (RF) exposure associated with a plurality of radios via a first controller among a plurality of controllers for a first time period; and
means for controlling the RF exposure associated with one or more radios of the plurality of radios via a second controller among the plurality of controllers for a second time period different from the first time period.
